(19) United States
(12) Patent Application Publication
(10) Pub. No.: US 2026/0285068 A1
(43) Pub. Date: Sep. 24, 2026

(54) THERMAL PRINTER

(71) Applicant: Seiko Instruments Inc., Chiba-shi (JP)

(72) Inventor: Taketo SANNOHE, Chiba-shi (JP)

(21) Appl. No.: 19/565,052

(22) Filed: Mar. 12, 2026

(30) Foreign Application Priority Data
Mar. 18, 2025 (JP) 2025-044051

(51) Int. Cl. B41J 11/70; B41J 2/32; B41J 3/407; B41J 11/04

(52) U.S. Cl. CPC B41J 11/703; B41J 2/32; B41J 3/4075; B41J 11/04

(57) ABSTRACT

A thermal printer includes a thermal head that prints on a recording medium and a platen roller that conveys the medium while contacting its adhesive surface. A fixed blade is arranged downstream of the thermal head, and a movable blade is arranged downstream of the platen roller. A non-adhesive member is positioned adjacent to the movable blade on the adhesive-surface side. The movable blade advances toward the fixed blade to cut the medium and retracts afterward. During cutting, the blade edge is positioned farther toward the distal end side than an end of the non-adhesive member, while during retraction it is positioned farther toward the proximal end side. This positional relationship causes the adhesive surface of the medium to contact the non-adhesive member and separate from the movable blade. As a result, the printer reliably peels adhesive media from the blade without requiring any dedicated peeling mechanism.

### RELATED APPLICATIONS

This application claims priority to Japanese Patent application No. JP2025-044051, filed on Mar. 18, 2025, the entire content of which is incorporated herein by reference.

### BACKGROUND OF THE INVENTION

### 1. Field of the Invention

The present invention relates to a thermal printer.

### 2. Description of the Related Art

Hitherto, there have been known printers such as a thermal printer including a thermal head that performs printing on a recording medium, and a fixed blade and a movable blade that cut the recording medium subjected to printing. For example, such a printer cuts the recording medium by pressing a blade edge of the movable blade against the recording medium arranged between the fixed blade and the movable blade. The recording medium is, for example, a recording sheet such as a label having an adhesive layer.

As the printer that cuts the recording sheet subjected to printing, a printer described in Japanese Patent Application Laid-open No. 2024-139915 has been known.

However, in the printer including the peeling mechanism with a peeling part (contact portion) that moves in the direction opposite to the advancing/retracting direction of the movable blade to peel off the recording sheet from the movable blade, a movable part for moving the peeling part may become worn and may fail, and thus there is a fear in that the recording sheet adhering to the movable blade cannot be peeled off stably. Further, such a printer is required to have a peeling part, a movable part, and the structure for fixing the peeling part and the movable part. This may complicate the parts configuration and may increase the size of the printer to secure a space for arranging those parts.

In view of the above-mentioned circumstances, the present invention has an object to provide a thermal printer capable of stably peeling off a recording medium adhering to a movable blade.

### SUMMARY OF THE INVENTION

In one aspect, a thermal printer includes a thermal head provided so as to be opposed to a printing surface of a recording medium, and configured to perform printing on the printing surface; a platen roller provided so as to be opposed to an adhesive surface opposite to the printing surface, and configured to convey the recording medium; a fixed blade arranged so as to be opposed to the printing surface, and provided more on a downstream side in a conveying direction of the recording medium than the thermal head; a movable blade arranged so as to be opposed to the adhesive surface, and provided more on the downstream side than the platen roller; and a non-adhesive member arranged so as to be opposed to the adhesive surface, and provided adjacent to the movable blade in the conveying direction, wherein the movable blade is configured to advance and retract in a direction of approaching and separating from the fixed blade, and has a blade edge that is formed at an end portion on an edge side of the movable blade opposed to the adhesive surface in an advancing/retracting direction of the movable blade, and that is configured to cut the recording medium, and wherein the blade edge is located more on the edge side than an end portion of the non-adhesive member on the edge side when the movable blade is moved close to the fixed blade to cut the recording medium, and is located more on a base end side opposite to the edge side in the advancing/retracting direction than the end portion of the non-adhesive member on the edge side when the movable blade that has cut the recording medium is separated from the fixed blade.

In some embodiments, the non-adhesive member is provided on each side of the movable blade in the conveying direction. In other embodiments, the non-adhesive member is made of silicone. In preferred examples, the non-adhesive member includes a plurality of protrusions protruding to the edge side from an end portion opposed to the adhesive surface. In certain embodiments, the non-adhesive member includes a plurality of protrusions protruding to the edge side from an end portion opposed to the adhesive surface. In other embodiments, the non-adhesive member includes a plurality of non-adhesive members provided at predetermined intervals in a width direction of the recording medium.

### BRIEF DESCRIPTION OF THE DRAWINGS

FIG. 1 is a front view for illustrating a thermal printer according to at least one embodiment of the present invention.

FIG. 2 is a side view for illustrating the thermal printer.

FIG. 3 is a sectional view taken along the line III-III in FIG. 1.

FIG. 4 is a view for schematically illustrating a printing unit and a cutting unit of the thermal printer.

FIG. 5 is a view for illustrating a movable blade of the cutting unit located at an initial position.

FIG. 6 is a view for illustrating the movable blade located at a cutting position.

FIG. 7 is a side view for illustrating an action of the movable blade.

FIG. 8 is a side view for illustrating an action of the movable blade.

FIG. 9 is a side view for illustrating an action of the movable blade.

FIG. 10 is a side view for illustrating an action of the movable blade.

FIG. 11 is a side view for illustrating an action of the movable blade.

### DETAILED DESCRIPTION OF THE PREFERRED EMBODIMENTS

At least one embodiment of the present invention is described with reference to the drawings.

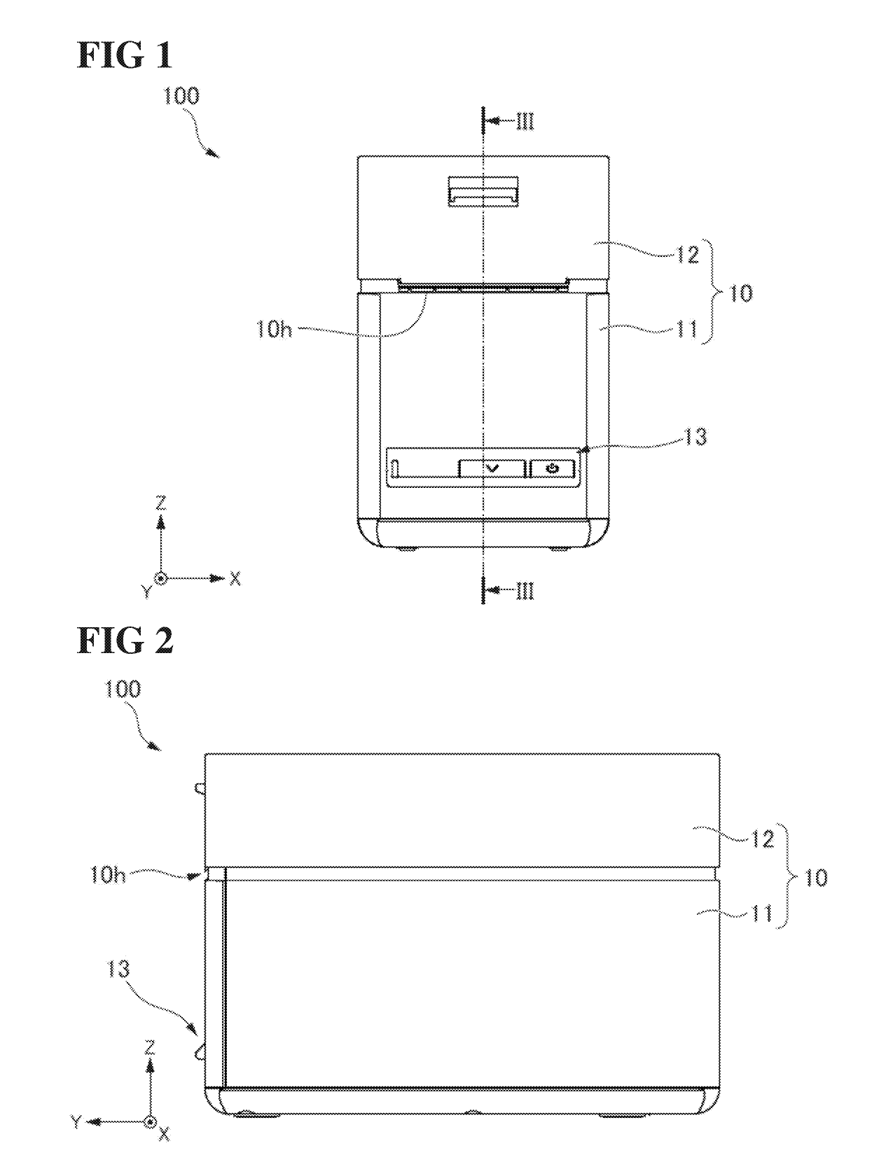

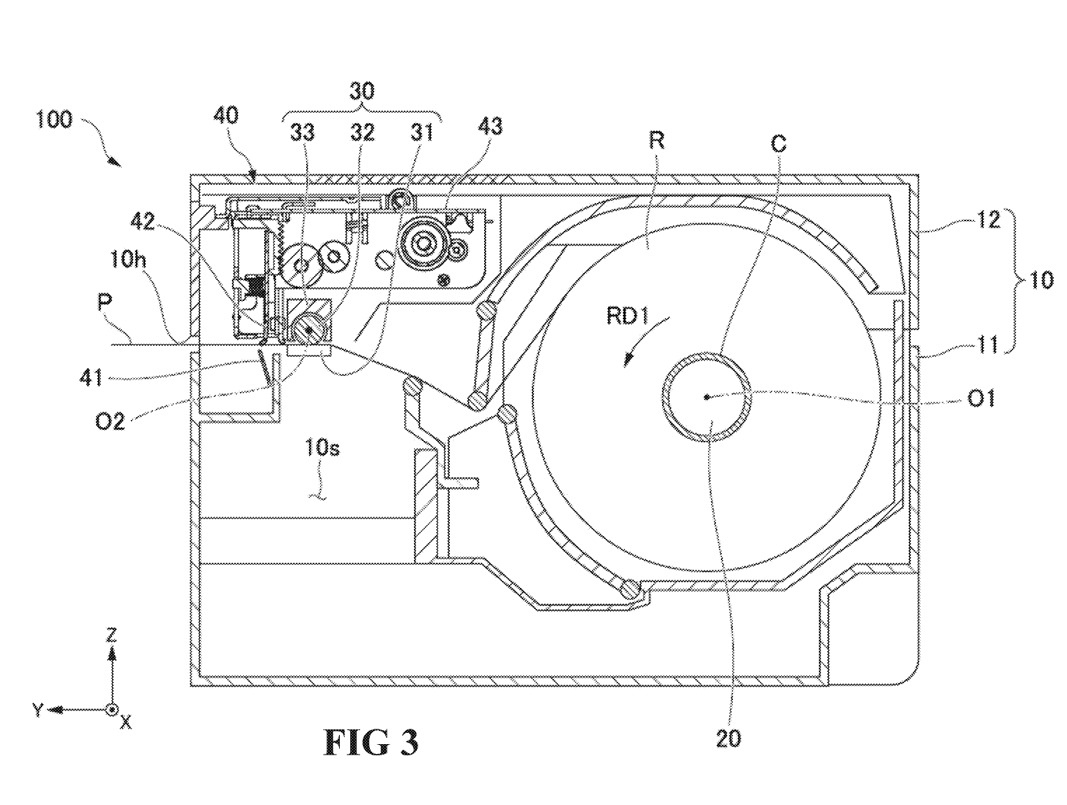

FIG. 1 is a front view for illustrating a thermal printer 100 according to the at least one embodiment of the present invention. FIG. 2 is a side view for illustrating the thermal printer 100. FIG. 3 is a sectional view taken along the line III-III in FIG. 1. The thermal printer 100 illustrated in FIGS. 1, 2, and 3 corresponds to the thermal printer 100 in a state of being placed on a placement surface such as the top of a table.

In the at least one embodiment, as illustrated in FIGS. 1, 2, and 3, in an X axis, a Y axis, and a Z axis that are orthogonal to each other, an extending direction of the X axis is defined as "right-and-left direction X", an extending direction of the Y axis is defined as "front-and-rear direction Y", and an extending direction of the Z axis is defined as "up-and-down direction Z".

The thermal printer 100 includes a housing 10, a roll holding portion 20, a printing unit 30, and a cutting unit 40. The thermal printer 100 is an apparatus capable of performing printing on a recording medium P such as a recording sheet.

The housing 10 includes a main body portion 11, a cover portion 12, and an operation unit 13. The main body portion 11 has a box shape that opens upward in the up-and-down direction Z. The cover portion 12 has a box shape that opens downward in the up-and-down direction Z. The cover portion 12 is mounted to the main body portion 11 so as to be capable of opening and closing an opening of the main body portion 11.

In a closed state in which the cover portion 12 covers the opening of the main body portion 11, an interior space of the main body portion 11 and an interior space of the cover portion 12 are in communication with each other in the up-and-down direction Z to form an interior space 10s of the housing 10 (see FIG. 3). In the closed state, the opening of the main body portion 11 and an opening of the cover portion 12 are opposed to each other in the up-and-down direction Z.

It is only required that the cover portion 12 be provided to the main body portion 11 so as to be capable of opening and closing the opening of the main body portion 11. The cover portion 12 may be removably mounted to the main body portion 11, or may be rotatably provided to the main body portion 11 by a hinge structure.

The operation unit 13 accepts operation on the thermal printer 100. For example, the operation unit 13 is provided with a power switch for turning on/off the power of the thermal printer 100, a print switch for causing the thermal printer 100 to perform printing actions on the recording medium P, and the like. In the at least one embodiment, the operation unit 13 is provided at the front of the main body portion 11 in the front-and-rear direction Y.

As illustrated in FIG. 3, the roll holding portion 20, the printing unit 30, and the cutting unit 40 are provided in the interior space 10s of the housing 10. The recording medium P is, for example, a recording sheet on which printing can be performed, and as illustrated in FIG. 3, the recording medium P has a roll portion R formed and wound around a core material C.

The roll holding portion 20 is a member that holds the roll portion R in the recording medium P. Specifically, the roll holding portion 20 holds the core material C. The core material C held by the roll holding portion 20 is, for example, a cylindrical member having a central axis extending in the right-and-left direction X. The roll holding portion 20 is, for example, a columnar member that can be inserted from the right-and-left direction X into a space enclosed by an inner peripheral surface of the core material C.

The roll holding portion 20 holds the core material C and the roll portion R in a rotatable manner about a central axis O1 extending in the right-and-left direction X. The roll portion R rotates in a rotating direction RD1 illustrated in FIG. 3, thereby feeding the recording medium P forward.

The recording medium P is subjected to printing by the printing unit 30 while being fed forward, and is cut by the cutting unit 40 while being further fed forward. An end portion of the recording medium P drawn from the roll portion R projects at the front of the housing 10 from the interior space 10s of the housing 10 through an opening 10h of the housing 10.

A user draws forward the recording medium P that has been cut by the cutting unit 40 after printing by the printing unit 30 and has projected through the opening 10h of the housing 10, and thus can take out, from the thermal printer 100, the recording medium P subjected to predetermined printing.

The printing unit 30 includes a thermal head 31, a platen roller 32, and a roller holding member 33. The printing unit 30 is arranged more on a front side than the roll holding portion 20 in the interior space 10s of the housing 10.

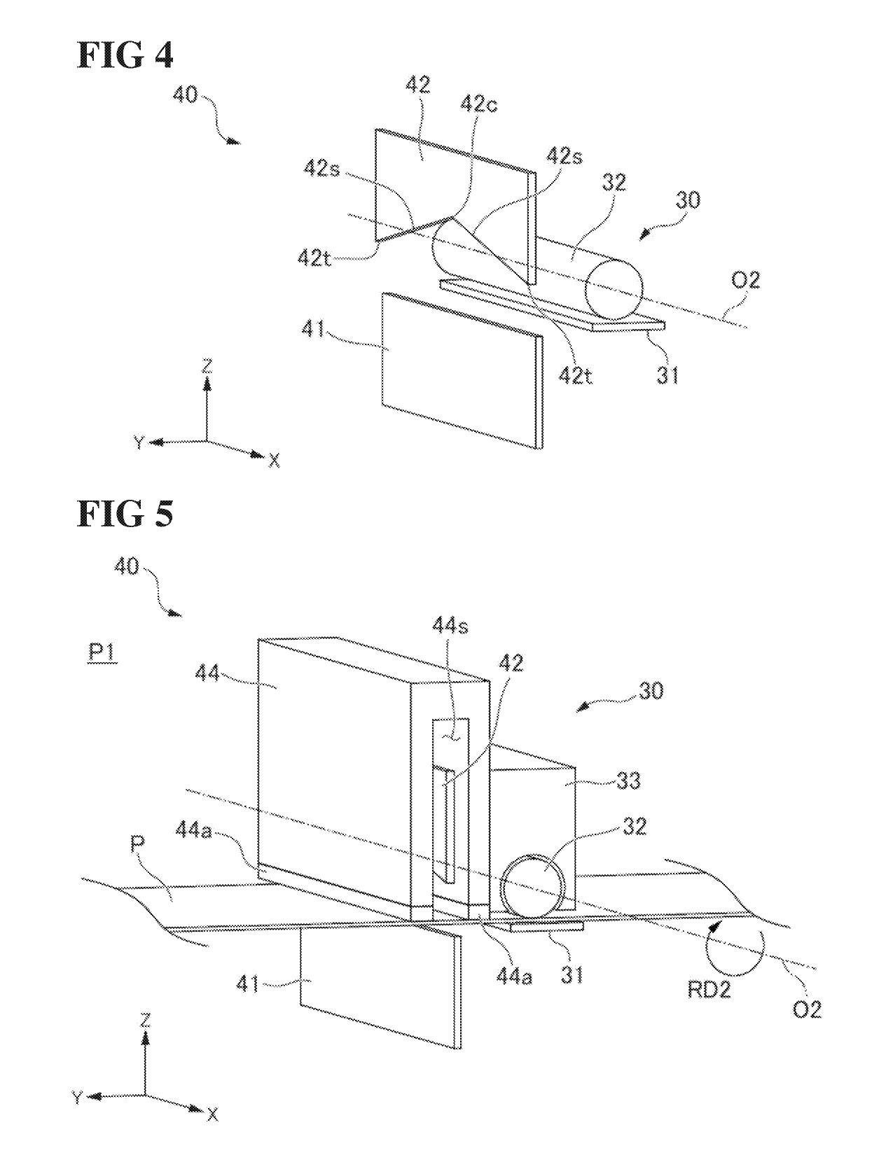

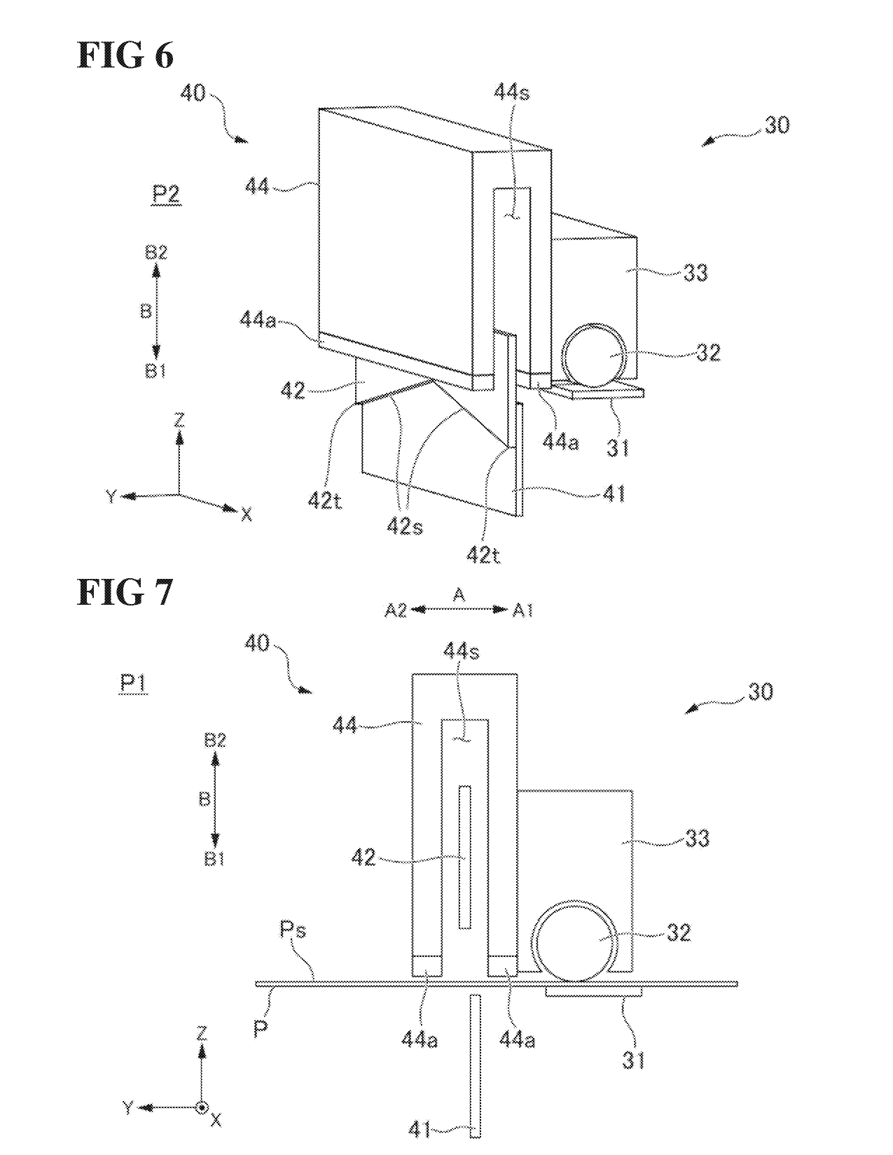

FIG. 4 is a view for schematically illustrating the printing unit 30 and the cutting unit 40. FIG. 5 is a view for illustrating a movable blade 42 of the cutting unit 40 located at an initial position P1. FIG. 6 is a view for illustrating the movable blade 42 located at a cutting position P2.

The thermal head 31 is a member capable of performing printing on the recording medium P. For example, the thermal head 31 includes a plurality of heating elements linearly aligned along the right-and-left direction X. The thermal head 31 is arranged in the interior space 10s of the housing 10 with the heating elements facing the recording medium P side.

The platen roller 32 is arranged so as to be opposed to the thermal head 31 in the up-and-down direction Z. The recording medium P drawn from the roll portion R is inserted between the thermal head 31 and the platen roller 32 in the front-and-rear direction Y.

In the at least one embodiment, the thermal head 31 is arranged below the recording medium P. The platen roller 32 is arranged above the recording medium P. The thermal head 31 and the platen roller 32 are arranged in the up-and-down direction Z while nipping the recording medium P therebetween. The recording medium P inserted between the thermal head 31 and the platen roller 32 is a sheet-like material extending in the right-and-left direction X and the up-and-down direction Z.

The thermal head 31 is arranged with the heating elements facing upward, and can perform printing on a lower surface of the recording medium P inserted between the thermal head 31 and the platen roller 32. In the following description, the lower surface of the recording medium P inserted between the thermal head 31 and the platen roller 32 is also referred to as "printing surface".

The platen roller 32 is a member that conveys forward the recording medium P drawn from the roll portion R. As illustrated in FIG. 4, the platen roller 32 is a cylindrical or columnar member having a central axis O2 extending in the right-and-left direction X.

The roller holding member 33 is a member that holds the platen roller 32 in the interior space 10s of the housing 10. The roller holding member 33 holds the platen roller 32 in a rotatable manner about the central axis O2. Under a state in which an outer peripheral surface of the platen roller 32 is held in contact with an upper surface of the recording medium P, the platen roller 32 rotates in a rotating direction RD2 illustrated in FIG. 5, and thus conveys the recording medium P inserted between the thermal head 31 and the platen roller 32 from a rear side to the front side.

The cutting unit 40 includes a fixed blade 41, the movable blade 42, a movable unit 43, and a movable blade guide wall 44. The cutting unit 40 is arranged more on the front side than the printing unit 30 in the interior space 10s of the housing 10.

The fixed blade 41 is arranged so as to be opposed to the printing surface of the recording medium P. That is, the fixed blade 41 is provided below the recording medium P. In the at least one embodiment, the fixed blade 41 is a plate-shaped member extending in the right-and-left direction X and the up-and-down direction Z. The fixed blade 41 is made of, for example, metal.

The movable blade 42 is arranged so as to be opposed to a surface of the recording medium P opposite to the printing surface. That is, the movable blade 42 is provided above the recording medium P. In the at least one embodiment, the movable blade 42 is a plate-shaped member extending in the right-and-left direction X and the up-and-down direction Z. The movable blade 42 is made of, for example, metal.

The movable unit 43 is a member that can move the movable blade 42 in the up-and-down direction Z. For example, the movable unit 43 includes a support member that supports the movable blade 42, and a mechanism (such as an electric motor) that can move this support member in the up-and-down direction Z.

The movable blade guide wall 44 is a member having a receiving space 44s (see FIG. 5) that can receive the movable blade 42 therein. For example, as illustrated in FIG. 5, the movable blade guide wall 44 is a member having a U shape that opens downward when viewed from the right-and-left direction X. The receiving space 44s is defined in an interior space of the U-shaped movable blade guide wall 44. It is not required that the movable blade guide wall 44 be strictly U-shaped.

The movable blade 42 is entirely received in the receiving space 44s when the movable blade 42 is located at the initial position P1 illustrated in FIG. 5. When the movable unit 43 is driven, the movable blade 42 is moved downward from the initial position P1 and moved close to the fixed blade 41.

As illustrated in FIG. 4, a lower end portion of the movable blade 42 is inclined upward toward a center of the movable blade 42 in the right-and-left direction X. In the following description, in the lower end portion of the movable blade 42, an end portion on each side in the right-and-left direction X is referred to as "pointed portion 42t", a center portion in the right-and-left direction X is referred to as "center portion 42c", and a portion inclining upward from the pointed portion 42t toward the center portion 42c is referred to as "inclined portion 42s".

When viewed from the front-and-rear direction Y, the lower end portion of the movable blade 42 has a V shape that opens downward and is formed by the center portion 42c, a pair of inclined portions 42s formed on both sides of the center portion 42c in the right-and-left direction X, and a pair of pointed portions 42t formed at lower ends of the pair of inclined portions 42s, respectively. It is not required that the lower end portion of the movable blade 42 be strictly V-shaped.

When the movable blade 42 is moved downward from the initial position P1, as illustrated in FIG. 6, the lower end portion of the movable blade 42 formed by the pointed portions 42t, the inclined portions 42s, and the center portion 42c projects downward from the receiving space 44s of the movable blade guide wall 44.

In the right-and-left direction X, a dimension of the movable blade 42 is equal to or larger than a dimension of the recording medium P. The lower end portion of the movable blade 42 projects from the receiving space 44s, and is pressed against the recording medium P inserted between the thermal head 31 and the platen roller 32, thereby cutting the recording medium P. The recording medium P is cut by the movable blade 42, and thus is divided into pieces in the front-and-rear direction Y.

The movable blade 42 is not always required to divide the entire recording medium P in a width direction thereof along the front-and-rear direction Y. In the at least one embodiment, the width direction of the recording medium P matches the right-and-left direction X. For example, the amount of downward movement of the movable blade 42 may be the amount of movement that allows the pointed portions 42t and the inclined portions 42s to be brought into contact with the recording medium P but does not allow the center portion 42c to be brought into contact with the recording medium P.

In this case, the movable blade 42 is not brought into contact with the center portion of the recording medium P in the width direction, and hence the center portion of the recording medium P in the width direction is not divided in the front-and-rear direction Y by the movable blade 42. That is, the recording medium P is cut by the movable blade 42, and only the center portion of the recording medium P in the width direction is connected.

In the following description, a position of the movable blade 42 at the time of cutting the recording medium P is referred to as "cutting position P2" (see FIG. 6). Further, the lower end portion of the movable blade 42 that cuts the recording medium P is also referred to as "blade edge". The blade edge of the movable blade 42 includes the pointed portions 42t and at least parts of the inclined portions 42s. The blade edge of the movable blade 42 may also include the center portion 42c.

FIGS. 7, 8, 9, 10, and 11 are each a side view for illustrating an action of the movable blade 42. In the following description, as illustrated in FIG. 7, a direction in which the recording medium P is conveyed by the platen roller 32 is defined as "conveying direction A". In the conveying direction A, the recording medium P is conveyed from an upstream side A1 to a downstream side A2. In the at least one embodiment, the conveying direction A matches the front-and-rear direction Y. The conveying direction A is not always required to match the front-and-rear direction Y.

Further, a direction in which the movable blade 42 advances and retracts between the initial position P1 and the cutting position P2 is defined as "advancing/retracting direction B". In the advancing/retracting direction B, the movable blade 42 is moved to an edge side B1 to thereby approach the fixed blade 41, and is moved to a base end side B2 to thereby separate from the fixed blade 41. In the at least one embodiment, the advancing/retracting direction B matches the up-and-down direction Z. The advancing/retracting direction B is not always required to match the up-and-down direction Z.

As illustrated in FIG. 7, the movable blade 42 located at the initial position P1 is entirely arranged in the receiving space 44s. In the recording medium P, an adhesive surface Ps is provided on a side opposite to the printing surface on which the thermal head 31 performs printing. The adhesive surface Ps is a layer having adhesive properties. The recording medium P is a seal label to which no backing paper or no release paper (liner) is affixed, and is also called a linerless label. The recording medium P having the adhesive surface Ps is used, for example, in the logistics industry and the food industry.

The platen roller 32 rotates in the rotating direction RD2 illustrated in FIG. 5, and thus conveys, to the downstream side A2, the recording medium P subjected to printing. In this manner, the portion of the recording medium P, on which printing has been performed by the thermal head 31, is arranged more on the downstream side A2 than the movable blade 42.

The adhesive surface Ps of the recording medium P does not adhere to the outer peripheral surface of the platen roller 32. For example, in the platen roller 32, at least the outer peripheral surface, which is to be brought into contact with the adhesive surface Ps, is made of silicone, thereby being capable of preventing the adhesive surface Ps from adhering to the platen roller 32.

In the movable blade 42, the above-mentioned blade edge is formed at an end portion on the edge side B1 opposed to the adhesive surface Ps. Further, in the at least one embodiment, the movable blade 42 is arranged slightly more on the downstream side A2 than the fixed blade 41.

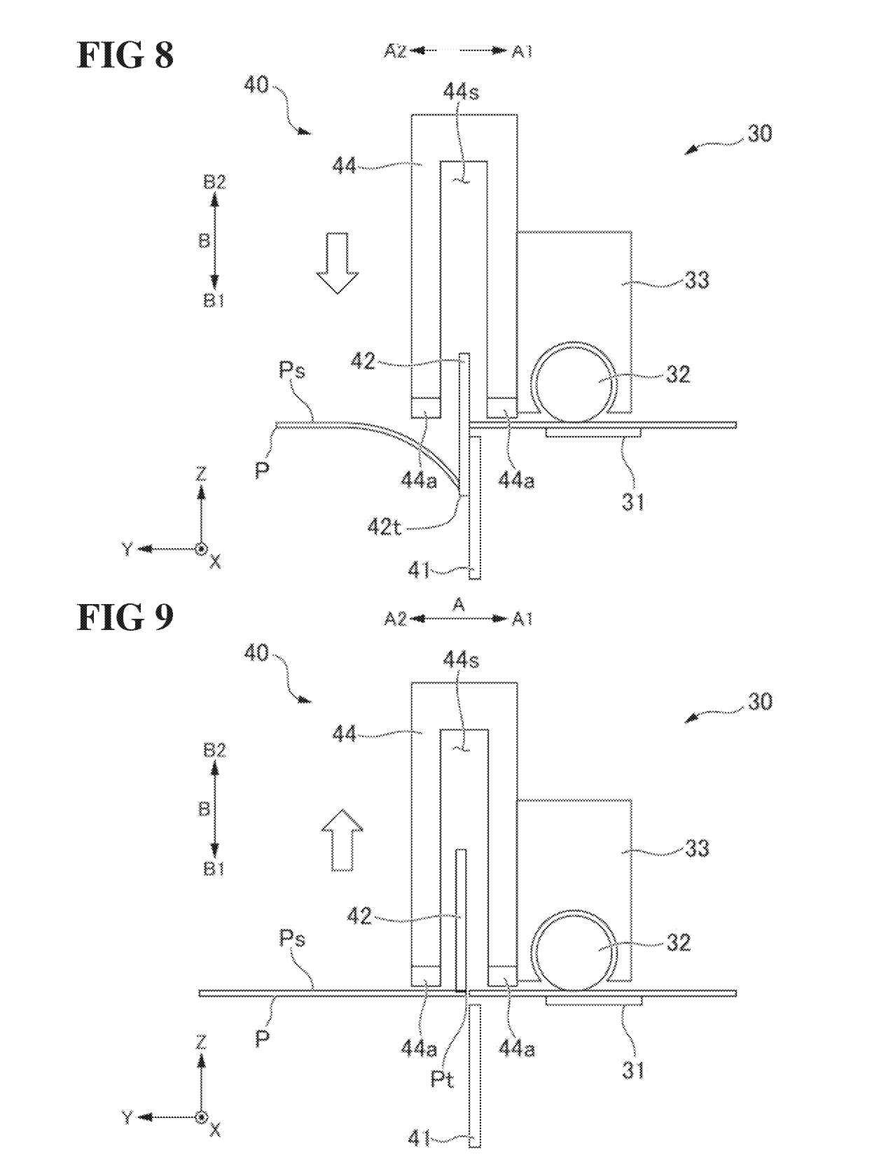

As illustrated in FIG. 8, the cutting unit 40 moves the movable blade 42 toward the edge side B1 to a position at which the end portion of the movable blade 42 on the edge side B1 and an end portion of the fixed blade 41 on the base end side B2 overlap each other in the up-and-down direction Z. In this manner, the blade edge of the movable blade 42 is pressed against the adhesive surface Ps, and thus the recording medium P is cut.

After cutting the recording medium P, the cutting unit 40 moves the movable blade 42 to the base end side B2 toward the initial position P1. At this time, as illustrated in FIG. 9, the adhesive surface Ps sticks to the movable blade 42, and hence a cut end Pt of the recording medium P is moved to the base end side B2 together with the movable blade 42. The cut end Pt of the recording medium P refers to an end portion on the upstream side A1 in the recording medium P on the downstream side A2 cut by the movable blade 42. For example, in the advancing/retracting direction B, the recording medium P illustrated in FIG. 9 is located at a position equivalent to that of the recording medium P illustrated in FIG. 7 before the recording medium P is cut by the movable blade 42.

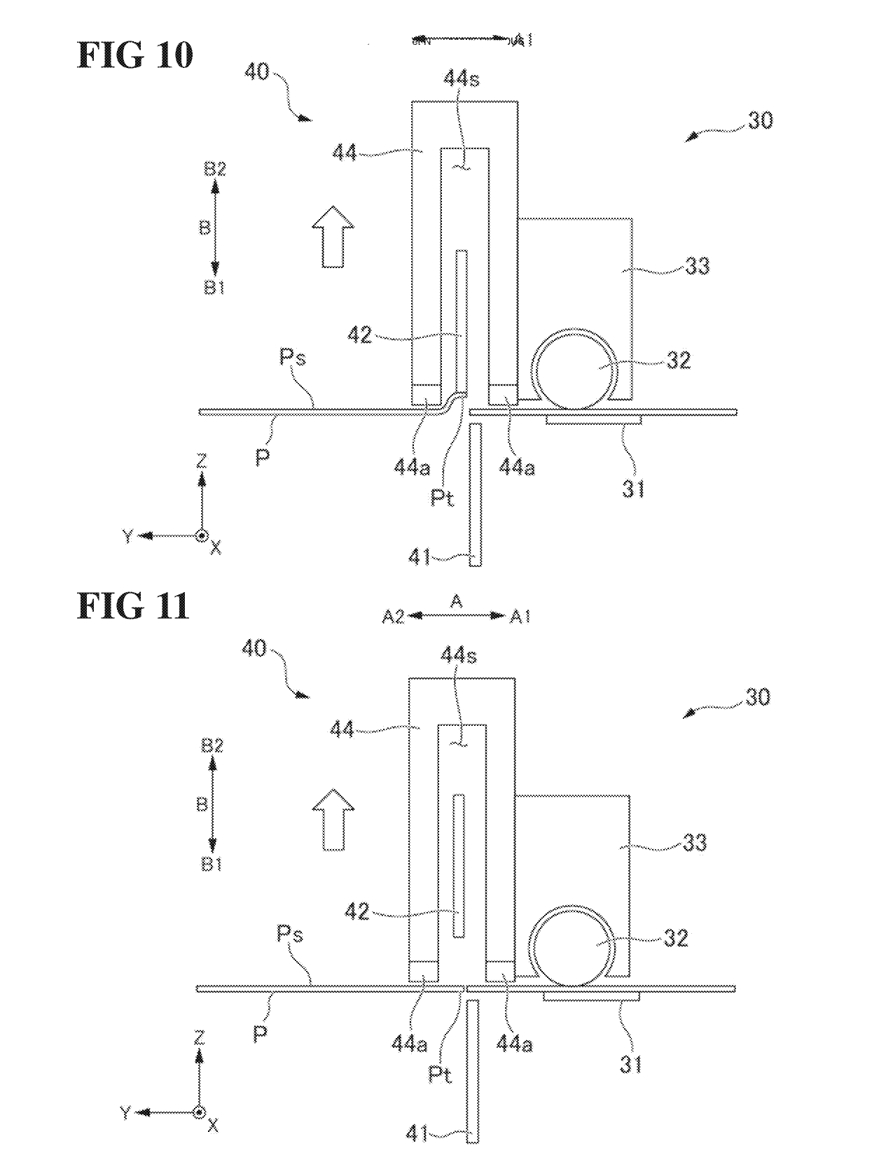

As illustrated in FIG. 10, the cutting unit 40 further moves the movable blade 42 to the base end side B2 toward the initial position P1. In this manner, the cut end Pt of the recording medium P adhering to the movable blade 42 is further moved to the base end side B2 together with the movable blade 42.

Here, a non-adhesive member 44a is provided at an end portion of the movable blade guide wall 44 on the edge side B1. The non-adhesive member 44a is provided so as to be opposed to the adhesive surface Ps of the recording medium P in the advancing/retracting direction B. Further, the non-adhesive member 44a is provided adjacent to the movable blade 42 in the conveying direction A. In the at least one embodiment, the non-adhesive member 44a is provided across an entire width of the movable blade guide wall 44 in the right-and-left direction X. As illustrated in FIG. 8, the blade edge of the movable blade 42 is located more on the edge side B1 than an end portion of the non-adhesive member 44a on the edge side B1 when the movable blade 42 is moved close to the fixed blade 41 to cut the recording medium P.

The adhesive surface Ps of the recording medium P does not adhere to the end portion of the non-adhesive member 44a on the edge side B1. For example, the non-adhesive member 44a is made of silicone, thereby being capable of preventing the adhesive surface Ps from adhering to the non-adhesive member 44a.

As illustrated in FIG. 10, the blade edge of the movable blade 42 is located more on the base end side B2 than the end portion of the non-adhesive member 44a on the edge side B1 when the movable blade 42 that has cut the recording medium P is separated from the fixed blade 41. As illustrated in FIG. 10, the recording medium P with the cut end Pt adhering to the movable blade 42 is pulled by the movable blade 42 that is being moved to the base end side B2, and approaches the non-adhesive member 44a. When the movable blade 42 is moved further to the base end side B2 than the position illustrated in FIG. 10, the adhesive surface Ps of the recording medium P is brought into contact with the non-adhesive member 44a.

The adhesive surface Ps of the recording medium P held in contact with the non-adhesive member 44a does not adhere to the non-adhesive member 44a. When the movable blade 42 is further moved to the base end side B2 from a state in which the adhesive surface Ps of the recording medium P is held in contact with the non-adhesive member 44a, the adhesive surface Ps of the recording medium P peels off from the movable blade 42.

Specifically, the movement of the recording medium P to the base end side B2 is restricted by the non-adhesive member 44a, and thus the recording medium P cannot follow the movable blade 42 that is being moved to the base end side B2, with the result that the cut end Pt of the recording medium P adhering to the movable blade 42 peels off from the movable blade 42.

At this time, the blade edge of the movable blade 42 is located more on the base end side B2 than the end portion of the non-adhesive member 44a on the edge side B1. For example, in the movable blade 42 illustrated in FIG. 11, a distance in the advancing/retracting direction B from the end portion of the non-adhesive member 44a on the edge side B1 to the blade edge of the movable blade 42 is larger than a distance in the conveying direction A from an end portion on the upstream side A1 of the non-adhesive member 44a arranged on the downstream side A2 to the cut end Pt of the recording medium P. With such arrangement of the non-adhesive member 44a, the cut end Pt of the recording medium P can be reliably peeled off from the blade edge of the movable blade 42.

When the movable blade 42 is moved to the base end side B2 under the state in which the adhesive surface Ps is held in contact with the non-adhesive member 44a, as illustrated in FIG. 11, the recording medium P is brought into non-adhesion to the movable blade 42 and the non-adhesive member 44a. A user can take out the portion on the downstream side A2 of the recording medium P cut by the movable blade 42 from the thermal printer 100 by pulling out the end portion of the recording medium P projecting forward through the opening 10h of the housing 10.

Under the state in which the adhesive surface Ps of the recording medium P adheres to the movable blade 42 or the non-adhesive member 44a, there is a risk in that a user may be unable to take out the recording medium P, or that the recording medium P may be damaged by pulling forward the recording medium P adhering to the movable blade 42.

With provision of the non-adhesive member 44a, the thermal printer 100 according to the at least one embodiment can peel off the recording medium P adhering to the movable blade 42 from the movable blade 42. Accordingly, a user can easily take out the recording medium P not adhering to the movable blade 42 from the opening 10h.

Further, the thermal printer 100 according to the at least one embodiment can peel off the recording medium P from the movable blade 42 by the non-adhesive member 44a arranged adjacent to the movable blade 42, without providing a peeling mechanism or the like that peels off the recording medium P from the movable blade 42 by moving in a direction opposite to a direction of movement of the movable blade 42. Thus, the thermal printer 100 according to the at least one embodiment can stably peel off the recording medium P adhering to the movable blade 42 without a risk of failure caused by wear on a movable part of the peeling mechanism.

Further, the thermal printer 100 according to the at least one embodiment can stably peel off the recording medium P from the movable blade 42 without providing the peeling mechanism or the like that peels off the recording medium from the movable blade 42 by moving in the direction opposite to the direction of movement of the movable blade 42, thereby being capable of preventing complication of the parts configuration, and increase in size of the thermal printer 100 for the purpose of securing a space for arranging the parts that form the peeling mechanism.

It is preferred that the non-adhesive member 44a be provided on each side (upstream side A1 and downstream side A2) of the movable blade 42 in the conveying direction A. When the recording medium P is cut by the movable blade 42, the cut portion of the recording medium P on the upstream side A1 may adhere to the movable blade 42.

After the movable blade 42 cuts the recording medium P and is moved to the base end side B2, the movable blade 42 returns to the initial position P1 at which the entire movable blade 42 is received in the receiving space 44s, and waits for the next cutting action. The printing unit 30 performs the next printing on the printing surface of the recording medium P, and feeds the recording medium P to the downstream side A2.

When the portion of the cut recording medium P on the upstream side A1 adheres to the movable blade 42, there is a risk in that the recording medium P may become jammed without being conveyed to the downstream side A2 so that a forward end portion of the recording medium P does not project through the opening 10h.

With arrangement of the non-adhesive member 44a on each side of the movable blade 42 in the conveying direction A, even when the portion of the cut recording medium P on the upstream side A1 adheres to the movable blade 42, the movement of the recording medium P to the base end side B2 can be restricted by the non-adhesive member 44a on the upstream side A1 of the movable blade 42, and the recording medium P can be peeled off from the movable blade 42 by moving the movable blade 42 to the base end side B2 under a state in which the recording medium P is held in contact with the non-adhesive member 44a.

The thermal printer 100 according to the at least one embodiment includes: the thermal head 31 that performs printing on the printing surface of the recording medium P; the platen roller 32 that is arranged so as to be opposed to the adhesive surface Ps opposite to the printing surface, and conveys the recording medium P; the fixed blade 41 provided more on the downstream side A2 of the recording medium P than the thermal head 31; the movable blade 42 provided more on the downstream side A2 than the platen roller 32; and the non-adhesive member 44a provided so as to be opposed to the adhesive surface Ps and provided adjacent to the movable blade 42 in the conveying direction A. The movable blade 42 can advance and retract in a direction (advancing/retracting direction B) of approaching and separating from the fixed blade 41, and has a blade edge that is formed at the end portion on the edge side B1 opposed to the adhesive surface Ps in the advancing/retracting direction B of the movable blade 42 and is capable of cutting the recording medium P. The blade edge of the movable blade 42 is located more on the edge side B1 than the end portion of the non-adhesive member 44a on the edge side B1 when the movable blade 42 is moved close to the fixed blade 41 to cut the recording medium P, and is located more on the base end side B2 than the end portion of the non-adhesive member 44a on the edge side B1 when the movable blade 42 that has cut the recording medium P is separated from the fixed blade 41.

According to the thermal printer 100 having such a configuration, the recording medium P adhering to the movable blade 42 can be peeled off without providing the peeling mechanism or the like that peels off the recording medium from the movable blade 42 by moving in the direction opposite to the direction of movement of the movable blade 42. Accordingly, it is possible to provide the thermal printer 100 capable of stably peeling off the recording medium P adhering to the movable blade 42.

The at least one embodiment of the present invention has been described above in detail with reference to the drawings. However, specific structures of the present invention are not limited to the at least one embodiment and encompass design modifications and the like without departing from the gist of the present invention. Further, the components described in the at least one embodiment described above and modification examples described below may be configured in combination with each other as appropriate.

### Modification Example 1

In the at least one embodiment described above, the cutting unit 40 includes the movable blade guide wall 44, but the mode of the cutting unit is not limited thereto. It is only required that the cutting unit include the non-adhesive member 44a arranged adjacent to the movable blade 42, and the cutting unit may include no movable blade guide wall 44.

### Modification Example 2

In the at least one embodiment described above, the non-adhesive member 44a is made of silicone to prevent the adhesive surface Ps from adhering to the non-adhesive member 44a, but the mode of the non-adhesive member is not limited thereto. It is only required that the non-adhesive member can prevent adhesion of the adhesive surface Ps of the recording medium P. For example, the non-adhesive member may be made of a fluorine-containing resin material to prevent adhesion of the adhesive surface Ps, or may be subjected to fluorine coating to prevent adhesion of the adhesive surface Ps.

Further, a contact area of the non-adhesive member with the adhesive surface Ps of the recording medium P may be reduced to prevent adhesion of the adhesive surface Ps. For example, the non-adhesive member may include a plurality of protrusions protruding to the edge side B1 from the end portion on the edge side B1 opposed to the adhesive surface Ps. The non-adhesive member can reduce the contact area with the adhesive surface Ps through contact of distal ends of the protrusions with the adhesive surface Ps, thereby being capable of preventing adhesion of the adhesive surface Ps.

When the non-adhesive member prevents adhesion of the adhesive surface Ps by reducing the contact area with the adhesive surface Ps, the material for the non-adhesive member is not limited to silicone or the like, but the non-adhesive member may be made of a material equivalent to that for the movable blade guide wall 44. Further, the movable blade guide wall 44 and the non-adhesive member may be integrally formed.

### Modification Example 3

In the at least one embodiment described above, the cutting unit 40 includes the non-adhesive member 44a arranged across the entire width of the movable blade guide wall 44, but the mode of the cutting unit is not limited thereto. The cutting unit may include a plurality of non-adhesive members provided at predetermined intervals in the width direction of the recording medium P.

When the plurality of non-adhesive members are arranged at predetermined intervals, the contact area between the non-adhesive members and the adhesive surface Ps can be reduced. For example, when a plurality of non-adhesive members made of silicone are arranged at predetermined intervals, adhesion of the adhesive surface Ps to the non-adhesive members can be more effectively prevented.

What is claimed is:

1. A thermal printer, comprising:
a thermal head provided so as to be opposed to a printing surface of a recording medium, and configured to perform printing on the printing surface;
a platen roller provided so as to be opposed to an adhesive surface opposite to the printing surface, and configured to convey the recording medium;
a fixed blade arranged so as to be opposed to the printing surface, and provided more on a downstream side in a conveying direction of the recording medium than the thermal head;
a movable blade arranged so as to be opposed to the adhesive surface, and provided more on the downstream side than the platen roller; and
a non-adhesive member arranged so as to be opposed to the adhesive surface, and provided adjacent to the movable blade in the conveying direction,
wherein the movable blade is configured to advance and retract in a direction of approaching and separating from the fixed blade, and has a blade edge that is formed at an end portion on an edge side of the movable blade opposed to the adhesive surface in an advancing/retracting direction of the movable blade, and that is configured to cut the recording medium, and
wherein the blade edge is located more on the edge side than an end portion of the non-adhesive member on the edge side when the movable blade is moved close to the fixed blade to cut the recording medium, and is located more on a base end side opposite to the edge side in the advancing/retracting direction than the end portion of the non-adhesive member on the edge side when the movable blade that has cut the recording medium is separated from the fixed blade.

2. The thermal printer according to claim 1, wherein the non-adhesive member is provided on each side of the movable blade in the conveying direction.

3. The thermal printer according to claim 1, wherein the non-adhesive member is made of silicone.

4. The thermal printer according to claim 2, wherein the non-adhesive member is made of silicone.

5. The thermal printer according to claim 1, wherein the non-adhesive member includes a plurality of protrusions protruding to the edge side from an end portion opposed to the adhesive surface.

6. The thermal printer according to claim 2, wherein the non-adhesive member includes a plurality of protrusions protruding to the edge side from an end portion opposed to the adhesive surface.

7. The thermal printer according to claim 1, wherein the non-adhesive member comprises a plurality of non-adhesive members provided at predetermined intervals in a width direction of the recording medium.
